(19) United States
(12) Patent Application Publication
(10) Pub. No.: US 2007/0274115 A1
(43) Pub. Date: Nov. 29, 2007

(54) Harmonics attenuator using combination feedback controller

(76) Inventors: Dennis Michaels, Rancho Santa Fe, CA (US); Jerry D. King, Mustang, OK (US); Anuag Chandra, Los Alamitos, CA (US); Suresh Gupta, Los Alamitos, CA (US)

Correspondence Address: FULWIDER PATTON LLP, 200 OCEANGATE, SUITE 1550, LONG BEACH, CA, 90802, US

(21) Appl. No.: 11/788,174

(22) Filed: Apr. 19, 2007

Related U.S. Application Data
(63) Continuation-in-part of application No. 11/080,584, filed on Mar. 15, 2005, now Pat. No. 7,212,421.

(51) Int. Cl. H02M 5/14

(52) U.S. Cl. 363/164

(57) ABSTRACT

A harmonics attenuator employing a combination controller that incorporates features of a classic controller and a state space controller to function as a hybrid controller unit. The PID portion of the classic controller regulates the steady state error and is separated from the pulse width modulated constant frequency signal generator that also comprises part of the classic controller. The PID portion is coupled with a state space controller such that the output of the PID controller, i.e., the steady state error correction, is input to the state space controller. The state space controller further receives as input variables a reference sinusoidal signal, the load current, the current across a pre-load filter capacitor, and the output voltage. From these inputs, the state space controller generates a transient error correction that is fed to a PWM signal generator for generating a sinusoidal output voltage signal with both steady state and transient error correction. The combination controller is thusly incorporated into an electrical feedback system referred to as a harmonics eater to attenuate higher order harmonics in an AC driven system.

### CROSS-REFERENCES TO RELATED APPLICATIONS

This application is a continuation in part (CIP) application from U.S. patent application Ser. No. 11/080,584, now U.S. Pat. No. 7,212,421, filed Mar. 15, 2005, the contents of which are fully incorporated herein by reference.

### FIELD OF THE INVENTION

The present invention relates to a harmonics attenuator, also known as a “harmonics eater,” using a Space State Vector Control feedback controller with rapid Constant Frequency response to balanced and unbalanced load conditions with minimal steady state error and low total harmonic distortion.

### BACKGROUND OF THE INVENTION

Power anomalies that arise in the day-to-day operations of the power system we all use and rely upon are an unfortunate reality, but these anomalies play havoc on the electrical equipment that utilize this power. The effect of power anomalies is unpredictable performance of the equipment, as well as the deleterious impact on the equipment's life span. That is, power anomalies result in excess wear and load on most electrical equipment that leads to premature failure or replacement. The unexpected failure of electrical equipment can be in the best cases inconvenient, and in the worst case catastrophic. While power anomalies can take many different forms, the most prevalent is power dips (sags) and momentary outages. Outages may not be complete loss of power, but rather a reduction to an unusable level. These sags and outages are present in all systems and directly lead to uncalculatable financial loss and down time.

One particular application that is most susceptible to outages and sags is medical imaging applications, such as magnetic resonance imaging (MRI). Power levels and power quality play an important role in the effectiveness of the MRI. The principal elements of MRI operation are a fixed magnetic field, gradient magnetic fields, and radio frequency generator (RF). To obtain a quality image without artifact, it is essential that these elements remain stable. Fluctuations and sags in the utility power cause temperature changes, along with calibration variations and unreliable operation, all of which negatively impact the usefulness of the MRI process. Not only is the operation impaired but the repair issues and logistics escalate exponentially with frequency and severity of the power issues.

Each sag causes an internal current surge in the electronic components that in turn re-creates internal voltage surges. When the applied voltage falls, the regulation systems of the MRI increase the current in compensating to maintain a constant power. Progressive sags degrade components, which leads to failure of the equipment. These failures are prohibitively expensive, not only in costs to repair or replace but also in the down time for the equipment and the recalibration to get the new or repaired equipment back up and running. To overcome the sags and outages, many operators turn to uninterrupted power supplies, or UPS. In particular, UPSs that are specifically designed to handle the asynchronous current surge demand of the MRI. The UPS is the most capable device for supplying a clean output of power during nominal as well as compromised power conditions. Such a power supply include the Gold Series ProMed UPS offered by WDC Technologies of San Diego, Calif., assignee of the present invention.

Uninterruptible power supplies (UPS) systems are devices that are commonly used to stabilize and maintain a back-up constant power supply for use in the event of an interruption in the main power distribution system. UPSs are used to compensate for voltage sags in the line voltage and provide instantaneous back-up voltage to equipment when the primary voltage power is interrupted. This can be critical to certain devices that cannot tolerate power interruptions, such as computers, medical devices, and safety equipment. The quality of the power supplied by a UPS system is compiled by various factors, including the quality of the output voltage regulation, the total harmonic distortion (Vthd) introduced by the UPS into the power distribution system, the output impedance of the UPS, the response of the UPS to transient events in the line voltage, and the response of the UPS to non-linear or distorted load requirements. Feedback control systems that control the UPS voltage, frequency and amplitude are pivotal to enhance the quality of the UPS output. An example of an arrangement and operation of a UPS and its controls is described in U.S. Pat. No. 6,768,223 to Powell et al., issued Jul. 27, 2004, the contents of which are fully incorporated herein by reference.

Prior art controllers for UPS systems traditionally use a single voltage control loop using proportional-integral (PI) control laws or proportional-integral-derivative (PID) control laws. These controllers may include a pulse width modulated frequency generator to smooth the frequency output to match the requirements of the particular load served. U.S. Pat. No. 5,654,591 to Mabboux et al., issued Aug. 5, 1997, the contents of which are fully incorporated herein by reference, illustrates the use of both of these types of controllers in a UPS system. PI controllers and PID controllers, collectively referred to herein as “classic” controllers, offer the benefits of minimal steady state error and are extremely stable, but classic controllers are ill-equipped to handle harmonic distortion at the output voltage which are exacerbated by non-linear loads. The transient response of a classic controller can also be problematic, with response time on the order of 5-50 milliseconds. Also, there is a typically drop in the voltage of a system using a classic controller when a full load is applied, and this voltage drop is proportional to the impedance of the system.

Another, less frequently used type of controller is the state space controller which is based on the set of “state” variables solved by differential calculus. An example of a state space controller is described in U.S. Pat. No. 5,047,910 to Levran et al., issued Sep. 10, 1991, the contents of which are fully incorporated herein by reference. State space controllers exhibit very good transient response time (less than 1 ms) and very low harmonic distortion in the range of one percent or less. However, several drawbacks exist in the use of state space controllers that largely exclude their use in most applications, including a relatively large steady-state error associated with the use of state space controllers that may be as high as 10% of the full load, an instability that can result in a modulation of the output voltage, and a frequency inconsistency with pulse width modulation that varies with conditions such as load, filter components, and DC bus voltage.

One by-product of such high power electronic equipment is the generation of harmonic currents. The harmonic currents are predominantly the 5^{th} and 7^{th} order, originated by six pulse rectifiers. The harmonic current magnitude worsens when the rectifiers are SCR controlled. Harmonic currents are carried through the power source and travel to a power feed system designed for sixty (60) Hertz. These harmonic currents create a voltage distortion across the feed wires as an i×r voltage drop association. The insertion of unwanted harmonics in the feed lines have costly effects. The bulk of the effects are ultimately seen as unwanted heat. The harmonic distortion disrupts and interferes with the correct operation of other electronic equipment, such as MRI equipment and all sensitive electronic equipment.

When harmonics are reflected to the utility, they are seen not only as voltage distortion but also as a complex power factor. Many utilities penalize the user as much as thirty percent (30%) yearly in surcharges for unacceptable power factors. Poor power factors, whether displacement or harmonic generated, demand additional Kva. To accommodate the demand requirement, larger transformers and cabling are needed.

Power protection devices are used to protect electronic equipment. Some do nothing to address load generated harmonics, passing them directly to the utility while others actually generate their own. The troublesome harmonics, 5^{th} and 7^{th}, are passed through the regulator directly to the utility. Newer power protection technologies still generate their own harmonics. Bulky expensive filters are added to the system to bring the harmonics within acceptable standards. Although the specifications for these power regulators claim input power factor of unity, these claims only address the displacement power as the harmonics remain.

What is needed is a simple, cost effective harmonics attenuator that can be used with power regulator systems to attenuate the odd order harmonics that contribute to distortion and poor power factors.

### SUMMARY OF THE INVENTION

The present invention is a harmonics eater that incorporates the benefits of both the classic controller and the state space controller using a combination controller that is stable and has minimal steady state error, and has a rapid transient response with low harmonic distortion. The combination controller divides the classic controller into two parts. The PID portion controlling the steady state error is separated from the pulse width modulated constant frequency signal generator. The PID portion is incorporated together in advance of a state space controller such that the output of the PID controller, i.e., the steady state error correction, is input to the state space controller. The state space controller further receives as input signals of a reference sinusoidal signal, the load current, the current across a pre-load filter capacitor, and the output voltage. From these inputs, the state space controller generates a transient error correction that is fed to the PWM portion of the classic controller for generating a sinusoidal output with both steady state and transient error correction. The sinusoidal output is directed to a power amplifier and filtered for delivery to the load.

The foregoing harmonics eater using the combination controller is well suited to clean utility current harmonics and output voltage harmonics as well as provide a super fast voltage correction on transient loads. Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is a block diagram of a classic or PID controller;

FIG. 2 is a block diagram of a state space controller;

FIG. 3 is a block diagram of a combination controller of the present invention;

FIG. 4 is a schematic diagram of a controller of the present invention;

FIG. 5 is a block diagram of a frequency converter using the combination controller of FIG. 3;

FIG. 6 is a block diagram of a power conditioner using the combination controller of FIG. 3;

FIG. 7 is a block diagram of an uninterruptible power supply (UPS) using the combination controller of FIG. 3;

FIG. 8 is an alternate transformer arrangement of the UPS of FIG. 6 using a single, three core transformer;

FIG. 9 is a graph of the 50% to 100% load transients for a linear load using the controller of the present invention;

FIG. 10 is a graph of the 0 to 100% load transients for a non linear load using the controller of the present invention; and

FIG. 11 is a schematic of a harmonics eater using the combination controller.

### DETAILED DESCRIPTION OF THE INVENTION

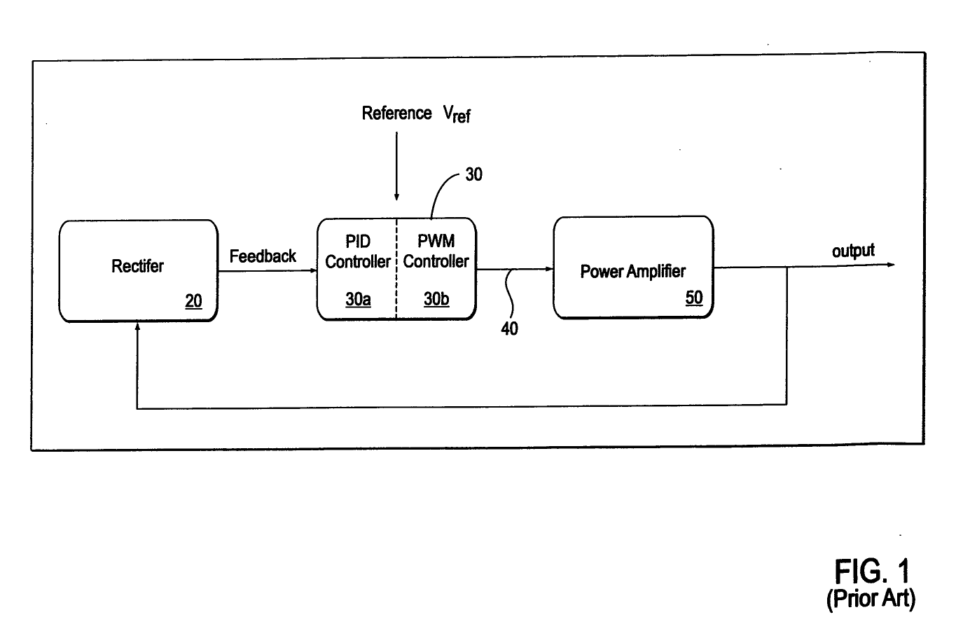

FIG. 1 illustrates a typical single loop voltage feedback system employing what is herein called a classic controller selected from the group of proportional-integral (PI), proportional-derivative (PD), and proportional-integral-derivative (PID) controllers. A rectifier 20 receives a sinusoidal output voltage and converts the AC voltage to an average DC value. The average value of the DC voltage feedback derived from the output voltage is then received by a classic controller 30, that compares the DC average value with a reference voltage V_{REF}. A steady state error signal associated with the average value of the output voltage is generated by the PID component 30a controller, which then combines the steady state error with a pulse width modulated signal generated by the PWM signal generator 30b portion of the classic controller 30 to yield a modified or conditioned signal 40. The conditioned signal is then supplied to a power amplifier 50 for enhancement of the conditioned signal, and the signal is then typically filtered using a inductor-capacitor filter (not shown) prior to making the output voltage available to an attached load.

In a close loop system such as that shown in FIG. 1, the error between the output voltage V_{O} and the pulse width modulated (PWM) signal 40 generated by the PWM component 30b of the controller 30 is the error e. The variable (e) represents the tracking error, the difference between the desired input value and the actual output. The error signal is sent to the PID controller 30a, which computes the derivative and the integral of the error signal. The signal derived by the PID controller is equal to the proportional gain (K_{P}) times the magnitude of the error plus the integral gain (K_{I}) times the integral of the error plus the derivative gain (K_{D}) times the derivative of the error. This can be represented by the following expression.
K_{P}e+K_{I}∫edt+K_{D}de/dt

The signal is sent to the PWM signal generator 30b, and a new output is obtained. The new output is rectified by the rectifier 20 and sent back to the PID controller 30a to find a new error signal, and the process is repeated over and over again. The use of PI and PID controllers are well established in the art of electrical feedback control systems because of their relative stability and because a very low steady state error can be achieved with the classic controller.

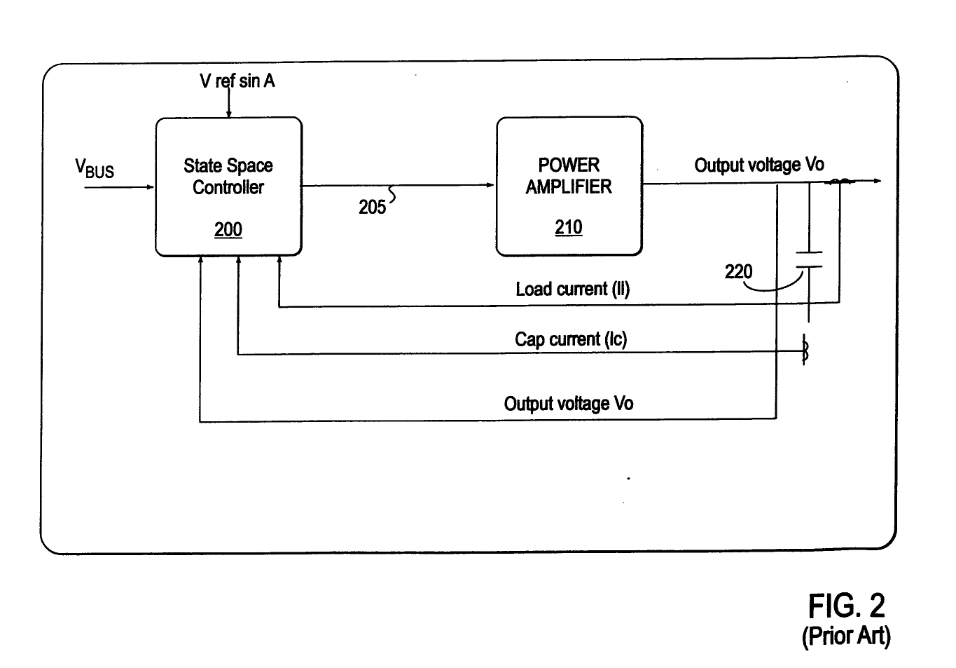

FIG. 2 illustrates a block diagram of a state space feedback controller. There are several different ways to describe a system of linear differential equations. The state-space representation is given by the equations:

$$\frac{ⅆ \vec{x}}{ⅆ t} = A \vec{x} + Bu$$

$$y = C \vec{x} + Du$$

where x is an n by 1 vector representing the state, u is a scalar representing the input, and y is a scalar representing the output. The Eigenvalues of A give the system poles. The controller design involves solving equations above to meet the control objectives. The details of the schematic configuration and mathematics associated with state space controllers are set forth in U.S. Pat. No. 5,047,910 to Levran et al., incorporated herein by reference, and accordingly its description is omitted herein for brevity.

The input to the state space controller 200 shown in FIG. 2 include a reference sinusoidal voltage signal (V_{REF Sin A}) generated from a controlled source selected to compliment the waveform of the output load requirements. The state space controller 200 also receives the DC bus voltage (V_{BUS}) representing an average voltage supplied by the input voltage source, the load current I_{L} corresponding to the current supplied to the recipient load, the output voltage V_{O}, and the current I_{C} across a capacitor 220 serving as a filter to the recipient load. As set forth in Levran et al., an electrical circuit is established to solve the state space equations and provide a control signal 205 to the power amplifier 210 for amplification and delivery to the output voltage terminal.

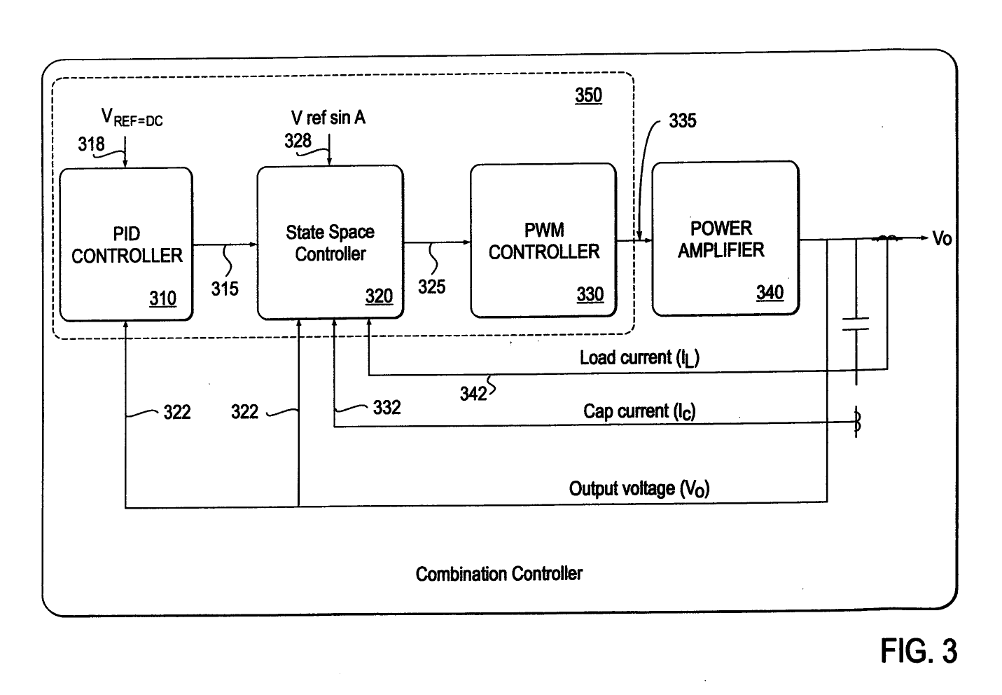

FIG. 3 illustrates a combination controller 350 of the present invention. The combination controller combines controllers 310, 320, 330 to function as a single hybrid controller that compensates for steady state error and significantly reduces harmonic disturbance in the system.

The combination controller 350 of FIG. 3 includes is a first controller 310 for regulating a steady state value of an amplified output voltage signal of said combination controller. Using either PI or PID (or other suitable alternative methods), controller 310 receives a reference DC voltage 318 for use as a comparator with the determined average value of the output voltage signal 322 to evaluate a steady state error in the feedback system. The reference DC voltage 318 (V_{ref}) can be applied from an isolated source or from the feedback loop itself. A second input of the controller 310 is an amplified output voltage signal 322 of said combination controller (V_{O}), and the controller 310 generates a steady state error correction signal 315 (E_{SS}) representing a difference between the average output voltage and an ideal average output voltage, and a signal representing same 315 is directly input to the second, or state space, controller 320.

The state space controller 320 cooperates with said first controller 310 in that it receives the steady state error signal 315 as well as a reference sinusoidal voltage 328 (V_{ref Sin A}). In order to solve the state space equations, the controller 320 also receives as inputs the amplified output voltage signal of said combination controller 322 (V_{O}), a current signal 332 corresponding to a pre-load filter capacitor (I_{C}), and an output current signal 342 (I_{L}). Using the five inputs (V_{ref Sin A}, E_{SS}, I_{C}, V_{O}, and I_{L}), the state space controller 320 generates a transient response error signal 325 (E_{T}) that is directly forwarded to a constant frequency pulse width modulated signal generator 330 incorporated in controller 350.

Controller 330 cooperates state space controller 320 by receiving the transient response error signal 325 (E_{T}) and generating a constant frequency pulse width modulated (PWM) sinusoidal voltage signal 335. Because the frequency of the output signal 325 from the state space controller 320 is variable—a disfavored characteristic of the amplified output signal—the PWM signal generator 330 converts the signal 325 to a uniform frequency signal. The signal 335 from the PWM controller 330 is communicated directly to a power amplifier 340 configured to receive said PWM sinusoidal voltage signal 335 and produce the amplified output voltage signal 322 (V_{O}) of said combination controller 350.

The combination controller 350 is a combination of the classical controller 30 and the state space controller 200, arranged in a manner that the two controllers compliment each other and improve the overall performance of the system. Such as controller can be applied to an electrical or mechanical system and the benefits of the combination controller will be realized. The controller 310 controls the steady state error value of the output voltage and keeps the system stable. The state space controller 320 controls the waveform, i.e., the harmonics, and regulates the transient response by comparing the output voltage to the reference sinusoidal signal. Finally, the controller 330 makes the PWM frequency constant and creates a sinusoidal wave form that is applied directly to the power amplifier 340.

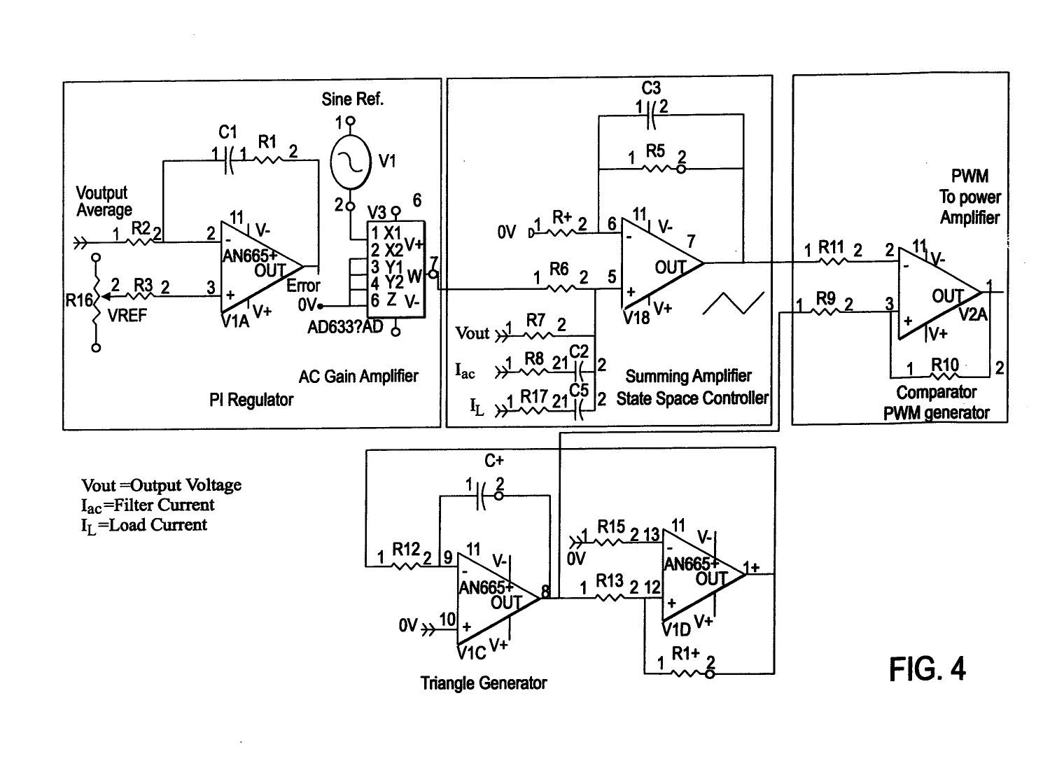

FIG. 4 illustrates a schematic diagram of the combination controller 350 shown in FIG. 3. The elements of the combination controller can be mounted on a single board to provide a compact, efficient solution to the feedback control problem. PI regulator 310 receives the average voltage output across resister R2 and a ground or DC reference voltage across resister R3 from DC source VREF having a resistor R16. If a PID controller were substituted for the PI controller, an inductor would be included in the RC circuit. The average output voltage and the reference DC voltage are fed to an amplifier 805, and which outputs a difference signal denoted ERROR. The average output signal is also communicated across an RC circuit using capacitor C1 and resister R1, where it is communicated along with the ERROR signal to an AC gain amplifier 810. The amplifier 810 also is coupled to a sine wave generator 815, and the AC gain amplifier outputs the steady state error correction signal 315 to the state space controller 320.

The state space controller 320 receives the steady state error correction signal 315 from the PI (or PID) controller 310 across resistor R6, and also receives the output voltage signal Vo across resister R7, the load current across resister R17 and capacitor C5, and the current across the filter capacitor across resistor R8 and capacitor C2. These inputs are delivered to a summing amplifier along with the signal OV, a reference sine wave signal passed across resistor R4. The reference signal OV is also routed around the amplifier using a capacitor C3 and resistor R5 in parallel. The output of the amplifier 820 is the transient response error signal 325 that is forwarded to the pulse width modulator controller 330.

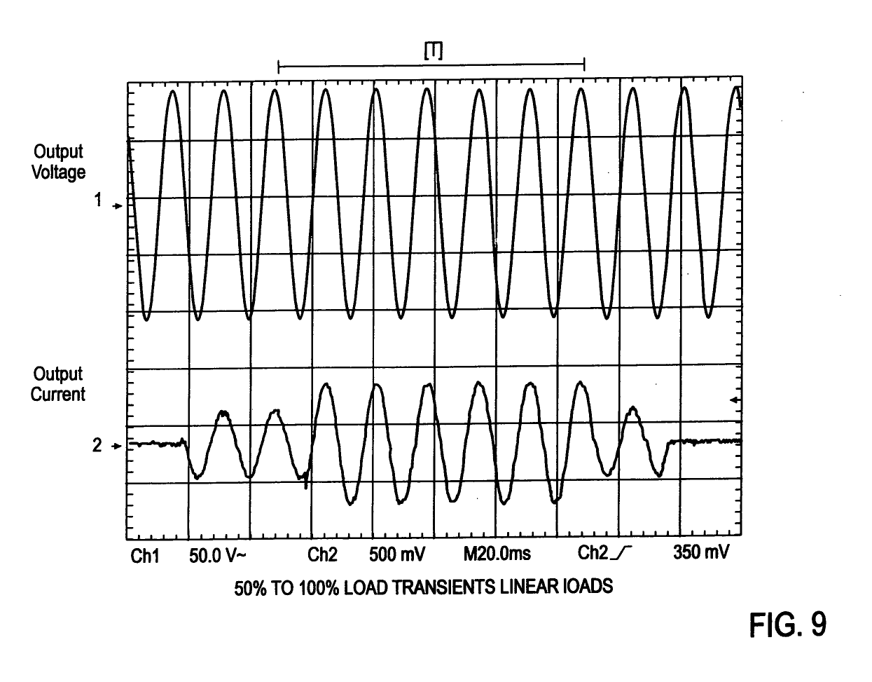

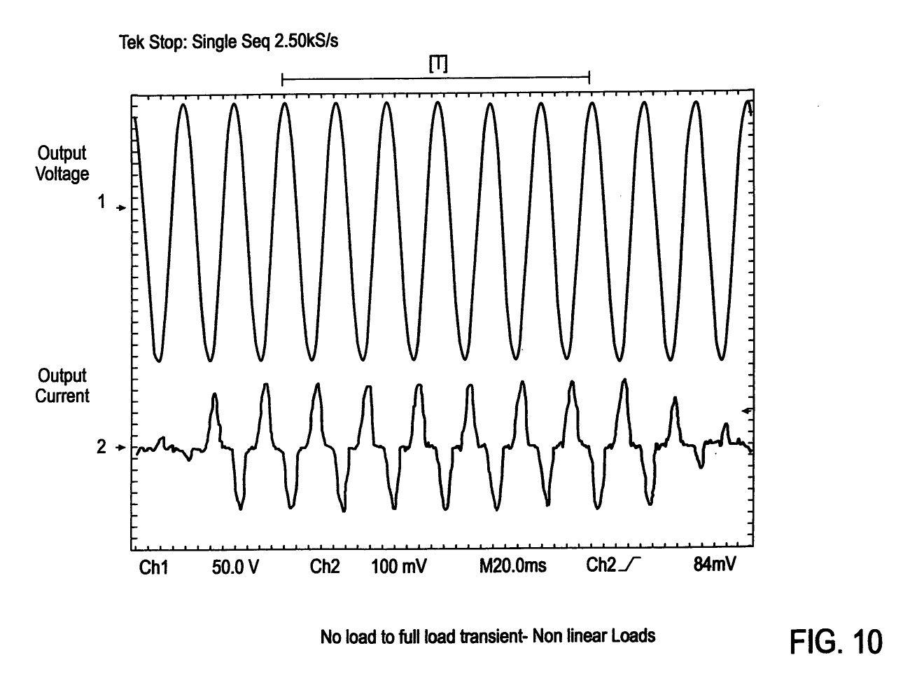

The pulse width modulator controller 330 compares the amplified output 335 from the product of the state space controller 320 output signal 325 across resistor R11 and the output 845 from the triangle wave generator circuit 850 across resistor R9, and generates a constant frequency pulse width modulated signal 335 that is directed to the power amplifier 340. The signal 335 incorporates the steady state error correction from the PI controller 310 and the transient error correction from the state space controller 320, and the resultant signal 335 is regulated by the triangle wave generator such that the amplified voltage output signal Vo is regular even under transient load conditions. Testing of no load to full load conditions with non-linear loading and half load to full load transients using linear loading shown in FIGS. 9 and 10 demonstrate that the controller of the present invention produces a constant and uniform output voltage signal under severe transient and non-linear load conditions.

APPLICATION NO. 1—FREQUENCY CONVERTER

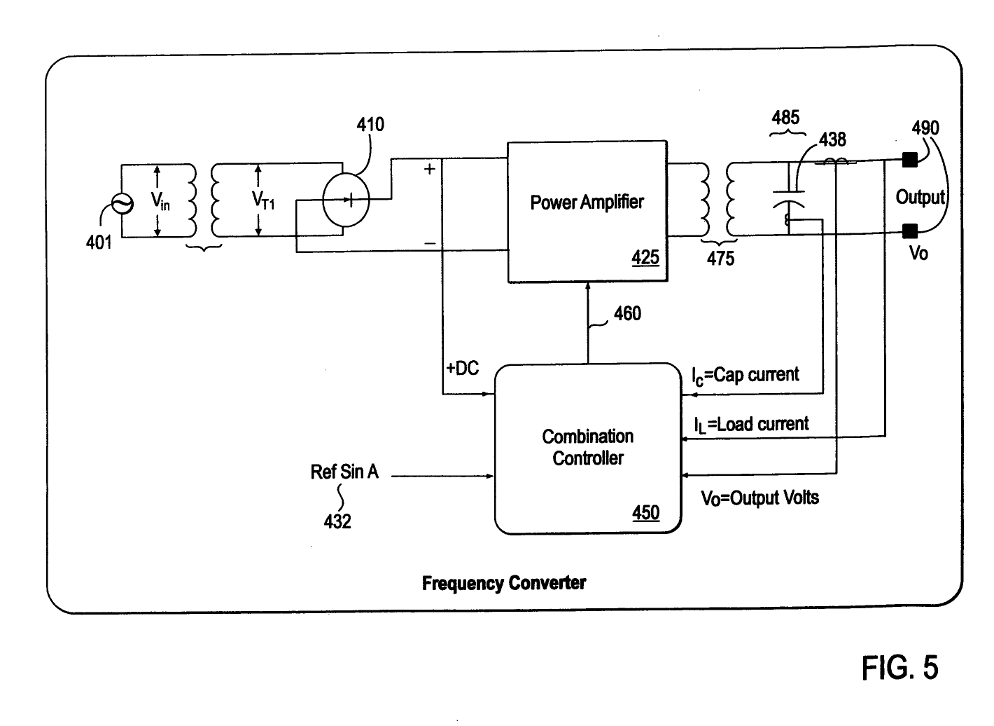

There are many applications for the combination controller shown in FIG. 3. A first exemplary application is shown in the frequency converter illustrated using a block diagram in FIG. 5. In FIG. 5, an input AC power source 401 operating at a first frequency and phase, is coupled to a first transformer 405 for stepping up (or down) the input voltage V_{IN}. The transformed voltage V_{T1} is then fed to a rectifier 410 that converts the AC power to a DC power. The rails 415a,b leading from the rectifier 410 are connected to terminals of a power amplifier 425. The positive rail 415a leading from the rectifier 410 is also connected to a combination controller 450, which also receives a sinusoidal reference signal 432. The combination controller 450 receives two current signals, the first representing the current delivered to the load (I_{L}) and the second representing the current (I_{C}) across the filter capacitor 438. The controller 450 processes the inputs and generates a new signal 460 having a frequency different from the input frequency of the input power source 405. The new signal is directed to the power amplifier 425 to enhance the signal 460 from the controller 450, and the enhanced signal is fed to a second transformer 475 and a filter 485 (including capacitor 438) before making the new voltage signal with new frequency available to the output terminals 490 connected to the load (not shown).

APPLICATION NO. 2—POWER CONDITIONER

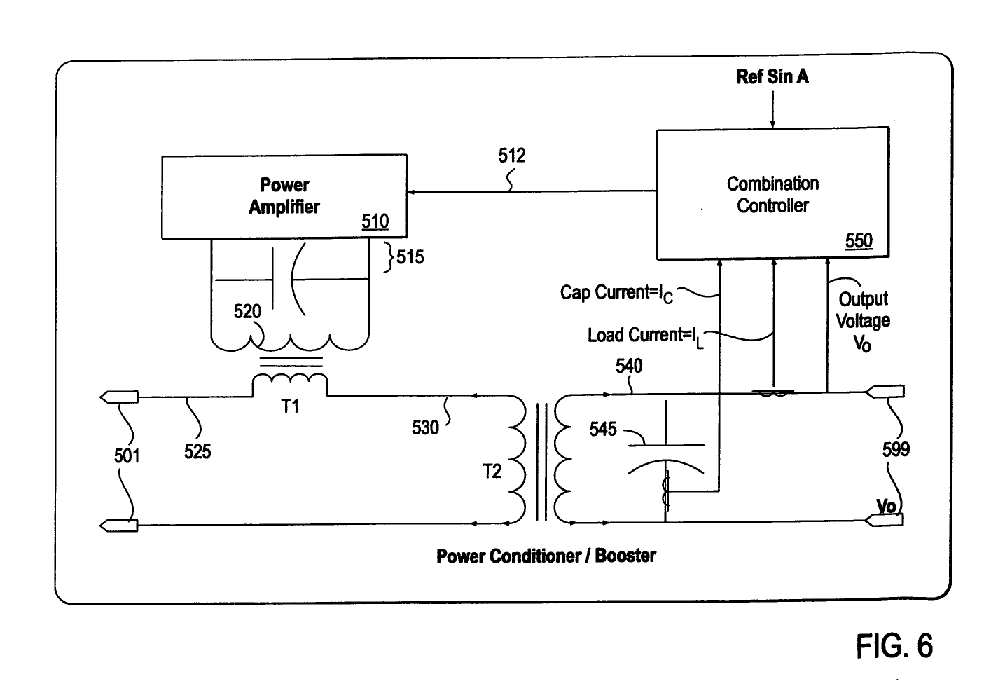

A second exemplary application of the combination controller of the present invention is depicted in the schematic for a power conditioner or power booster as illustrated in FIG. 6. The terminals 501 coupled to an input voltage source (not shown) forms a continuous circuit that is coupled to a series transformer T1 and an output transformer T2. The series transformer T1 serves to condition the voltage of the input source using a feedback loop in connection with a combination controller 550 of the present invention. The controller 550 has the construction and operation as described in FIG. 3 and is coupled to the output voltage, load current, pre-load filter capacitor, and a reference sine wave signal generator. The controller 550 sends a constant frequency pulse width modulated signal 512 having steady state and transient error correction to the power amplifier 510 for amplification of the conditioned signal 512. The amplified signal is processed with a filter 515 and directed to the coils 520 of transformer T1, which in turn regulates the input voltage signal 525. The regulated voltage signal 530 is passed through a second transformer T2 used to step up the voltage signal for application to the load. The stepped up voltage signal 540 is filtered using capacitor 545 and connected to output terminals 599 for delivery to a connected load.

APPLICATION NO. 3—UNINTERRUPTIBLE POWER SUPPLY

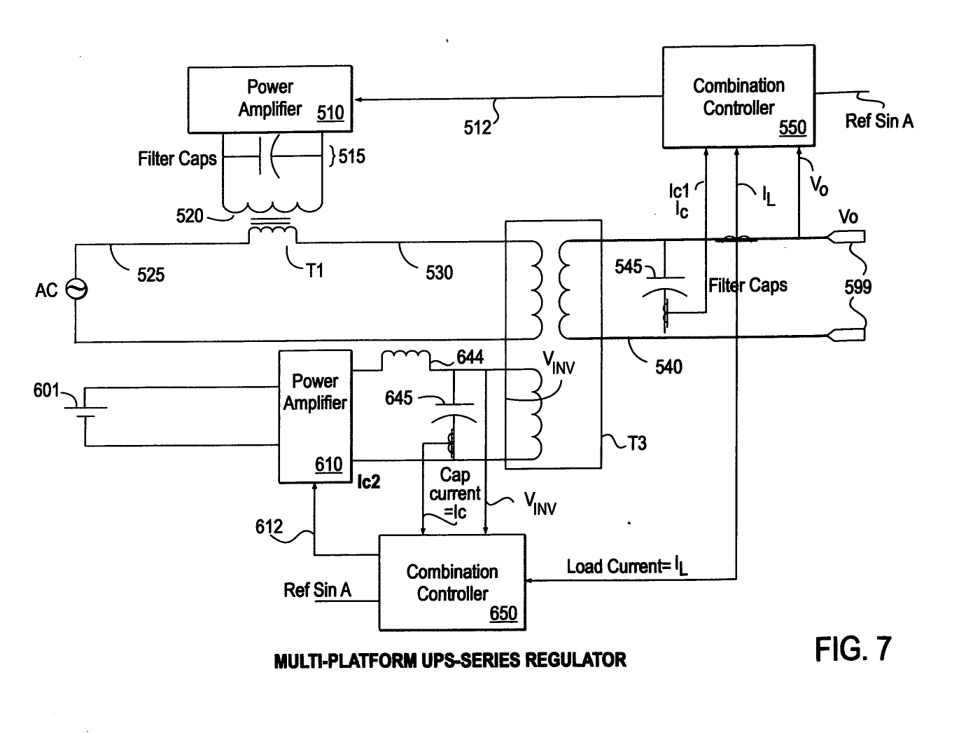

The third exemplary application of the controller of the present invention is depicted in the block diagram of the cross platform uninterruptible power supply of FIG. 7. It can be appreciated that the UPS incorporates the power conditioner of FIG. 6 in combination with an inverter circuit coupled to a DC power supply to form the UPS. With the components of the power conditioner previously described above, further description of FIG. 7 begins with the inverter circuit. The output transformer T2 has been replaced with a three winding transformer T3 that couples both the conditioned or regulated voltage signal 530 and the output from the inverter circuit V_{INV} to the pre-filtered output voltage signal 540. A battery supply 601 or alternative suitable reserve DC voltage is coupled to a power amplifier 610 driven by a combination controller 650 of the construction and operation described with respect to FIG. 3. The controller 650 receives the load current I_{L} and a current across capacitor 645, and further receives a reference sinusoidal signal. An inverter voltage V_{INV} also known as a shunt voltage is used to drive the transformer T3 when the input voltage signal falters is fed back to the combination controller 650 in a feedback loop to regulate the voltage through the three winding transformer T3. A sinusoidal control signal 612 with steady state and transient error correction processed through a constant frequency pulse width modulator to the power amplifier 610, and filtered using the inductor 644 and capacitor 645 prior to communicating the signal to the transformer T3. The DC power supply 601 kicks in when the AC power supply is interrupted or there is a discontinuity/instability in the power supply, and the inverter circuit takes over to provide a steady power flow to the output terminals 599. One of ordinary skill in the art will appreciate that the foregoing can readily be implemented for a three phase system (or any other polyphase system) using the above described elements for each phase.

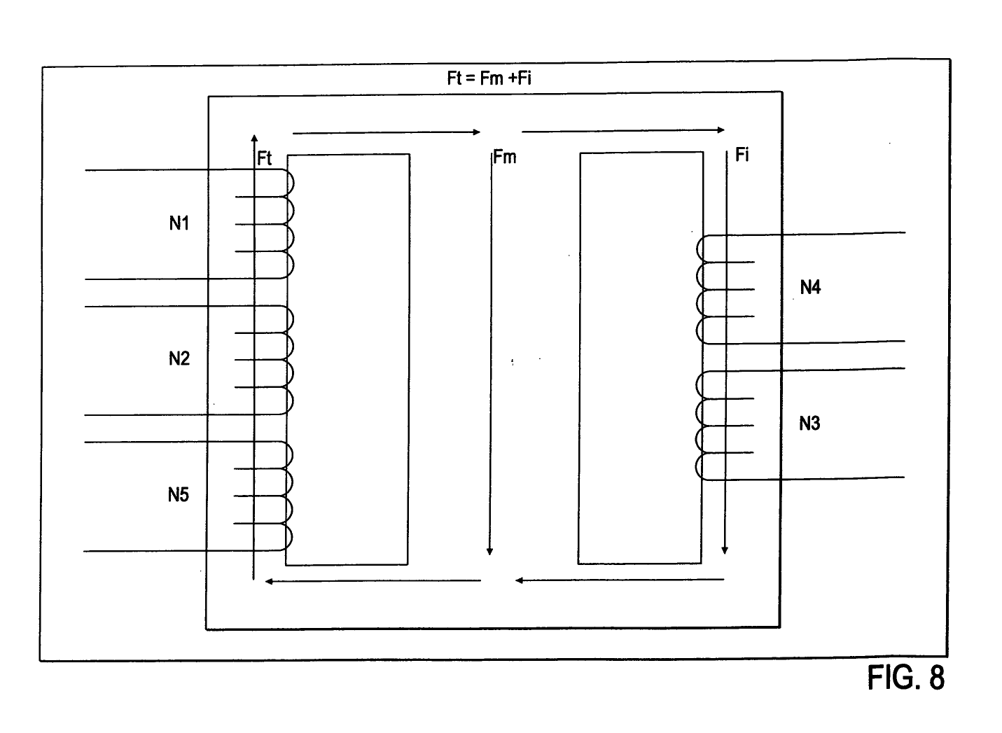

FIG. 8 illustrates an alternative transformer arrangement for a uninterruptible power supply using the combination controller of FIG. 7. In FIG. 8, a single three core transformer arrangement replaces the two transformer arrangement of FIG. 7 for use with the UPS, where the series regulation (previously accomplished with the series transformer) is now accomplished by changing the flux in the outer 820,830 and the middle core 810 of the three core transformer 800. The change in flux in the outer winding and middle winding allows the output voltage Vo across the winding N5 to be varied, where the output voltage is the sum of the voltage across windings N4 and N5. The winding N4 is connected in series with the input voltage Vi or winding N5 to regulate the output voltage. Here, the utility power Vi is coupled to the single transformer 800 at winding N1. Using the combination controller of FIG. 3 to adjust the voltage of first inverter, the fine regulation of the output voltage, including harmonics regulation, is maintained. The second inverter is coupled to input winding N3 for course regulation of the output voltage Vo. The fine regulation of the output voltage is accomplished with the first inverter at N2 using the combination controller of FIG. 3. This embodiment is less limited in the size of the series transformer in relation to the output regulation limits.

APPLICATION NO. 4—HARMONICS EATER

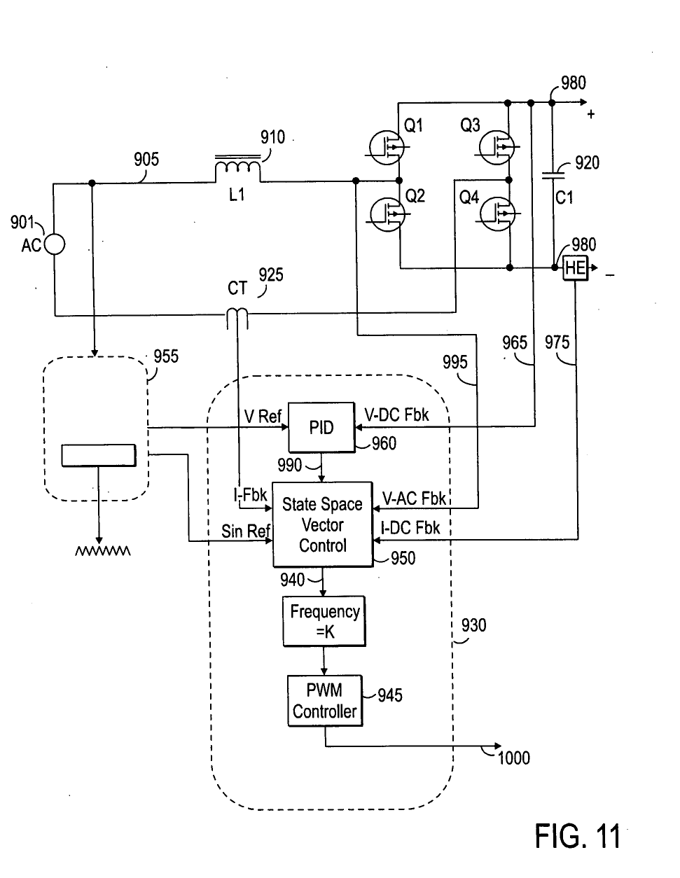

FIG. 11 illustrates a fourth novel and useful application of the combination controller featuring a harmonics attenuator, or “harmonics eater.” A harmonics eater mitigates higher order harmonics that result from power supplies that reflect back to the utility and affect the operation of the utility The harmonics eater of FIG. 11 produces a regulated DC output and regeneration control without reflecting harmful higher order harmonics to the utility. The device also uses the combination controller to establish a regenerated power factor, either leading or lagging, to assist the utility.

An input AC source 901 operating at a first frequency and phase drives a first circuit 905 including a line inductor 910 and a capacitor 920. The voltage across the capacitor (C1) 920, Vₒᵤₜ, is applied to a series of transistors Q1, Q2, Q3, and Q4 driven by the combination controller 930. The gates of the transistors Q1, Q2, Q3, and Q4 control the output voltage Vₒᵤₜ. Current transformer (CI) 925 allows the current in circuit 905 to be input to the combination controller 930 at the state space vector control 950. The voltage signal from the AC source 901 is fed to the line synchronization sine wave generator 955, which generates the reference voltage signal (V Ref) for the PID controller 960 and the reference sine wave (Sin Ref) for the state space vector controller 950. The output DC voltage (V-DC Fbk) across the capacitor 920 is connected to the PID controller 960 via bus 965, and the current (I-DC Fbk) is connected to the state space vector control 950 via bus 975.

When a load is applied across the output terminals 980, the current (I-Fdbk) is communicated from the current transformer 925 to the state space vector controller 950 and the line synchronization sine generator generates V Ref to the PID controller 960, which also receives the output voltage V-DC fdbk. The PID controller 960 generates the steady state error between the two inputs and delivers the steady state input signal 990 to the steady state vector controller 950. The steady state vector controller uses the steady state error signal 990 as an input, along with the reference sine signal (Sin Ref), the load current I-Fbk from the current transformer 925, the voltage (V-AC Fbk) in the circuit 905 delivered across bus 995, and the output current I-DC Fbk from bus 975, and generates the transient error signal 940, which is used to calculate the frequency dependent power factor K. The power factor and the transient error signal are sent to the pulse width modulator controller 945 which outputs a signal 1000. This output signal of the combination controller 930 is used to drive the signals on the transistors Q1-Q4 to eliminate harmonics propagating downstream which can then be reflected upstream back to the AC voltage supply 901.

With DC power applied to the output 980 from and external source or via regenerative energy as a result of an EMF from sudden unloaded motors or electromagnet discharge, the control 930 reverses the transistor Q1-Q4 operation to direct the energy to the source 901 (typically the utility) in a regenerative mode. The controller immediately initiates an operational quadrant shift from the first quadrant to the fourth to redirect the energy. The power delivered to the utility is forced to a sine function by the sine generator 955, assuring the current harmonic content is maintained well below the IEEE519 standard for reflected current harmonics. It is this regenerative ability that enhances and differentiates the harmonic eater from all other DC conversion devices. For example, a standard controller with regeneration requires several seconds to reverse the signal, but the harmonics eater of the present invention requires only microseconds to reverse without ITHD introduced into the utility.

Various changes and modifications may be made in the construction and mode of operation of the control system and devices utilizing said control system described above. These changes, which are in accordance with the spirit of the invention, come within the scope of the appended claims and are embraced thereby.

We claim:

1. A harmonics attenuator comprising:
a line inductor connected to an AC voltage source;
a capacitor establishing an output voltage
a plurality of transistors arranged in a bridge across said capacitor;
a current transformer for scaling a circuit current to generate an output current signal;
a line synchronization sine wave generator coupled to said AC power circuit; and
a combination controller comprising:
a first controller for regulating a steady state value of said output voltage, said first controller receiving said output voltage and a reference DC voltage from said line synchronization sine wave generator, and said first controller generating a steady state error correction signal therefrom;
a second controller cooperating with said first controller and configured to receive said steady state error correction signal, a reference sinusoidal voltage from said line synchronization sine wave generator, said output current signal, an AC voltage output from the line inductor, and the current across the capacitor, and said second controller generating a transient response error signal therefrom; and
a third controller cooperating with said second controller and configured to receive said transient response error signal, said third controller generating a constant frequency pulse width modulated (PWM) sinusoidal voltage signal that is communicated back to the transistors to arrest harmonics.

2. The combination controller of claim 1 wherein said first controller performs proportional-plus-integral (PI) control to regulate the STEADY STATE value.

3. The combination controller of claim 2 wherein said first controller further performs proportional-plus-integral-plus-derivative (PID) control to regulate the steady state value.

4. The combination controller of claim 1 wherein said first controller is constructed to produce said steady state error with a value of less than one percent.

5. The combination controller of claim 4 constructed to produce a total harmonic distortion (THD) with a value of less than one percent.
